(19) United States
(12) Patent Application Publication
(10) Pub. No.: US 2016/0251108 A1
(43) Pub. Date: Sep. 1, 2016

(54) Construct With Locking Features

(71) Applicant: Graphic Packaging International, Inc., Atlanta, GA (US)

(72) Inventor: Greg Gungner, Ontario (CA)

(21) Appl. No.: 15/051,889

(22) Filed: Feb. 24, 2016

Related U.S. Application Data
(60) Provisional application No. 62/176,795, filed on Feb. 27, 2015.

(51) Int. Cl. B65D 5/68; B31B 1/60; B31B 1/90; B65D 5/20

(52) U.S. Cl. CPC B65D 5/685; B65D 5/20; B31B 1/60; B31B 1/90; B31B 2201/6095; B31B 2201/9061

(57) ABSTRACT

A construct for holding at least one article. The construct comprises a plurality of panels extending at least partially around an interior of the construct. The plurality of panels can at least partially form a corner of the construct. The construct further comprises locking features for at least partially interlocking the construct with a separate construct. The locking features can comprise at least a locking tab and an engagement aperture, and the locking tab can be proximate the engagement aperture at the corner of the construct.

### CROSS-REFERENCED TO RELATED APPLICATIONS

This application claims the benefit of U.S. Provisional Patent Application No. 62/176,795, filed on Feb. 27, 2015.

### INCORPORATION BY REFERENCE

The disclosure of U.S. Provisional Patent Application No. 62/176,795, which was filed on Feb. 27, 2015, is hereby incorporated by reference for all purposes as if presented herein in its entirety.

### BACKGROUND OF THE DISCLOSURE

The present disclosure generally relates to cartons, trays, and/or other constructs for holding food products and/or other types of articles. More specifically, the present disclosure relates to constructs that may include interlocking features.

### SUMMARY OF THE DISCLOSURE

In general, one aspect of the disclosure is generally directed to a construct for holding at least one article. The construct comprises a plurality of panels extending at least partially around an interior of the construct. The plurality of panels can at least partially form a corner of the construct. The construct further comprises locking features for at least partially interlocking the construct with a separate construct. The locking features can comprise at least a locking tab and an engagement aperture, and the locking tab can be proximate the engagement aperture at the corner of the construct.

In another aspect, the disclosure is generally directed to a package for holding at least one article. The package can comprise a first construct forming a tray of the package. The tray can comprise a plurality of tray panels extending at least partially around an interior of the package, a tray locking tab, and a tray engagement aperture. The plurality of tray panels can at least partially form a tray corner, the tray locking tab can extend from a tray panel of the plurality of tray panels at the tray corner, and the tray engagement aperture can extend at the tray corner. A second construct can form a lid of the package. The lid can comprise a plurality of lid panels extending at least partially around an interior of the package, a lid locking tab, and a lid engagement aperture. The plurality of lid panels can at least partially form a lid corner, the lid locking tab can extend from a lid panel of the plurality of lid panels at the lid corner, and the lid engagement aperture can extend at the lid corner. The lid locking tab and the lid engagement aperture can be for selectively engaging the respective tray engagement aperture and tray locking tab to at least partially interlock the tray and the lid.

In another aspect, the disclosure is generally directed to a blank for forming a construct for holding at least one article. The blank can comprise a plurality of panels for being disposed at least partially around an interior of the construct formed from the blank to at least partially form a corner of the construct formed from the blank. The blank further can comprise locking features for at least partially interlocking the construct formed from the blank with a separate construct. The locking features can comprise at least a locking tab and an engagement aperture. The locking tab can be proximate the engagement aperture at the corner when the construct is formed from the blank.

In another aspect, the disclosure is generally directed to a method of forming a construct. The method can comprise obtaining a blank comprising a plurality of panels and locking features. The locking features can comprise at least a locking tab and an engagement aperture. The method further can comprise positioning the panels of the plurality of panels to extend at least partially around an interior of the construct. The positioning the panels can comprise forming a corner of the construct, wherein the locking tab is proximate the engagement aperture at the corner of the construct.

In another aspect, the disclosure is generally directed to a method of forming an assembly. The method can comprise obtaining a first construct and a second construct. The first construct can form a tray of the package. The tray can comprise a plurality of tray panels extending at least partially around an interior of the package, a tray locking tab, and a tray engagement aperture. The plurality of tray panels can at least partially form a tray corner, the tray locking tab can extend from a tray panel of the plurality of tray panels at the tray corner, and the tray engagement aperture can extend at the tray corner. The second construct can form a lid of the package. The lid can comprise a plurality of lid panels extending at least partially around an interior of the package, a lid locking tab, and a lid engagement aperture. The plurality of lid panels can at least partially form a lid corner, the lid locking tab can extend from a lid panel of the plurality of lid panels at the lid corner, and the lid engagement aperture can extend at the lid corner. The method further can comprise at least partially interlocking the first construct with the second construct by disposing at least one of the lid locking tab and the tray locking tab to be at least partially received in the respective tray engagement aperture and lid engagement aperture.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is an exterior plan view of a blank used to form a construct according to an exemplary embodiment of the present disclosure.

FIG. 2 is a top perspective view of an erected construct according to the exemplary embodiment of the present disclosure.

FIG. 3 is a bottom perspective view of the construct of FIG. 2.

FIG. 4 is a perspective view of an interior of the construct of FIG. 2.

FIG. 5 is an interior perspective view of an end of the construct of FIG. 2.

FIG. 6 is a perspective view showing the assembly of two of the constructs of FIG. 2 to form an assembly according to the exemplary embodiment of the present disclosure.

FIG. 7 is a top perspective view of the assembly according to the exemplary embodiment of the present disclosure.

FIG. 8 is a bottom perspective view of the assembly of FIG. 7.

FIG. 9 is a perspective view of an end of the assembly of FIG. 7.

Corresponding parts are designated by corresponding reference numbers throughout the drawings.

### DETAILED DESCRIPTION OF THE EXEMPLARY EMBODIMENTS

The package or assembly of the present disclosure can be useful in containing one or more products (e.g., a food product) or other articles such as any suitable type of product that can be stored, transported, cooled, frozen, heated, and/or cooked (e.g., in a microwave oven). Some suitable products could comprise a sandwich, hot dog, French fries, nachos, fruits, vegetables, popcorn, cuts of meat, or any other suitable food product or other article. Further, the package of the present disclosure can be used for heating, cooking, browning, crisping, etc. the food product by use of a heating or cooking device such as a microwave oven. It is understood that food products (or non-food products) other than the food products listed herein may be contained in the package. Further, products contained in this package may be generally rectangular, triangular, round, square, irregular, or any other shape. In this specification, the terms “inner,” “interior,” “outer,” “exterior,” “lower,” “bottom,” “upper,” and “top” indicate orientations determined in relation to fully erected and upright packages.

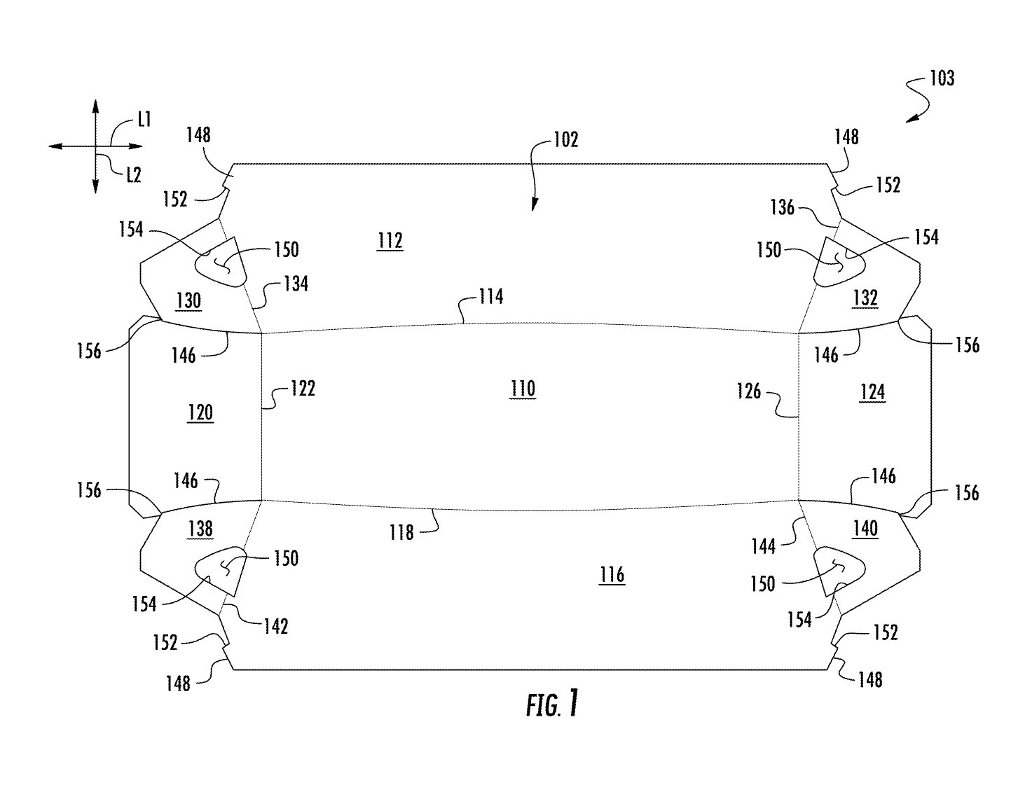

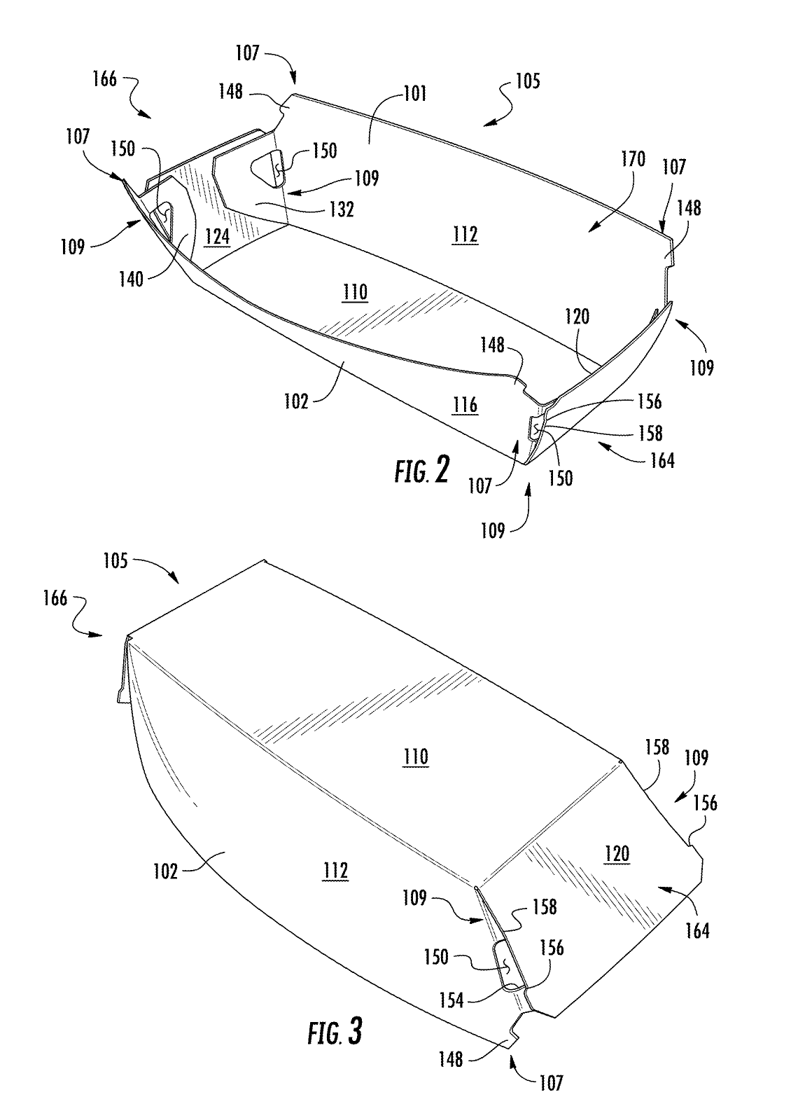

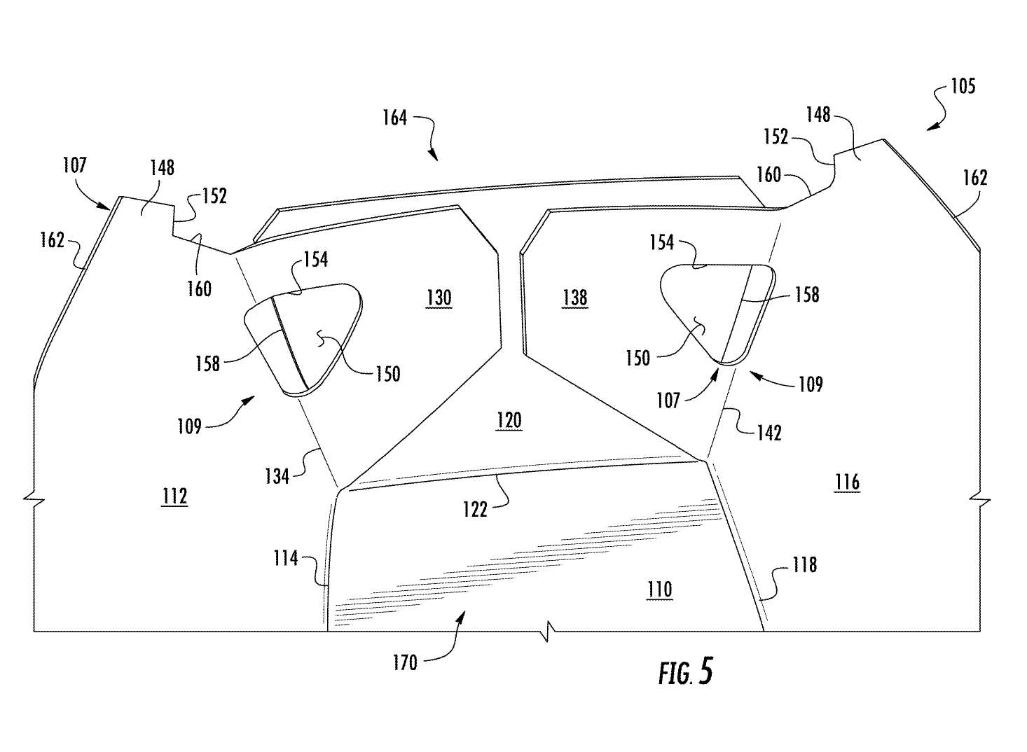

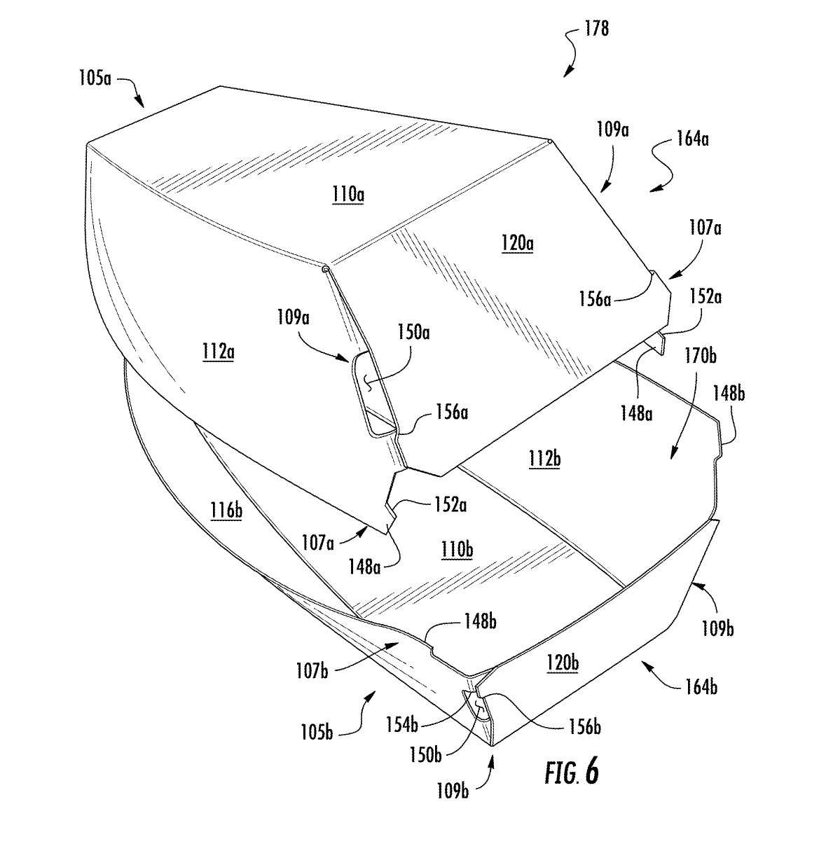

FIG. 1 is a plan view of a blank, generally indicated at 103, used to form a construct 105 (FIGS. 2-5) of an exemplary embodiment of the disclosure. In one embodiment, two constructs 105, which can be identical, substantially identical, generally identical, or similar to one another, can form a respective lid 105a and tray 105b of a package 178 and can be interlocked to form an assembly 180 (FIGS. 6-9). The construct 105 can include locking features 107 at each corner 109 so that the two constructs can be at least partially interlocked in the assembly 180. In the illustrated embodiment, the blank 103 and the construct 105 can have an interior surface 101 (FIGS. 2 and 4) and an exterior surface 102 (FIGS. 1-3). The construct 105 is used to hold and/or support and/or cover a food product (not shown), such as a French bread pizza, sandwich, hot dog, turnover, burrito, meats, French fries, and/or any other food product, during serving (e.g., at a quick-service and/or takeout restaurant), cooking, refrigerating, freezing, etc. of the food product. In one embodiment, at least a portion of the construct 105 may have an element (not shown) for use in cooking, heating, browning, and/or shielding (e.g., a microwave energy interactive element, such as, but not limited to, a susceptor) mounted thereto. Alternatively, a microwave energy interactive element can be omitted from the construct 105. In an alternative embodiment, the construct 105 can hold and/or support and/or cover a non-food item or article.

The blank 103 has a longitudinal axis L1 and a lateral axis L2. The blank 103 includes a central panel 110 foldably connected to a first side panel 112 at a first longitudinal fold line 114. A second side panel 116 is foldably connected to the central panel 110 along a second longitudinal fold line 118. In the illustrated embodiment, the longitudinal fold lines 114, 118 are slightly curved so that the middle of central panel 110 bulges outwardly somewhat. Alternatively, the longitudinal fold lines 114, 118 could be straight or could be alternatively curved without departing from the disclosure. A first end panel 120 is foldably connected to the central panel 110 along a first lateral fold line 122 at one longitudinal end of the central panel 110, and a second end panel 124 is foldably connected to the central panel 110 along a second lateral fold line 126 at another longitudinal end of the central panel 110.

In the illustrated embodiment, the blank 103 includes end flaps 130, 132 foldably connected at respective ends of the first side panel 112 along respective fold lines 134, 136. End flaps 138, 140 are respectively foldably connected at respective ends of the second side panel 116 along the respective fold lines 142, 144. In one embodiment, each of the end flaps 130, 138, 132, 140 is at least partially separable from the respective end panel 120, 124 along respective cut lines 146. The blank 103 could be otherwise shaped, arranged, positioned, and/or configured without departing from the disclosure. For example, the end flaps 130, 138, 132, 140 could be foldably connected to the respective end panels 120, 124. Alternatively, the end flaps 130, 132, 138, 140 could be omitted from the blank 103 without departing from the disclosure.

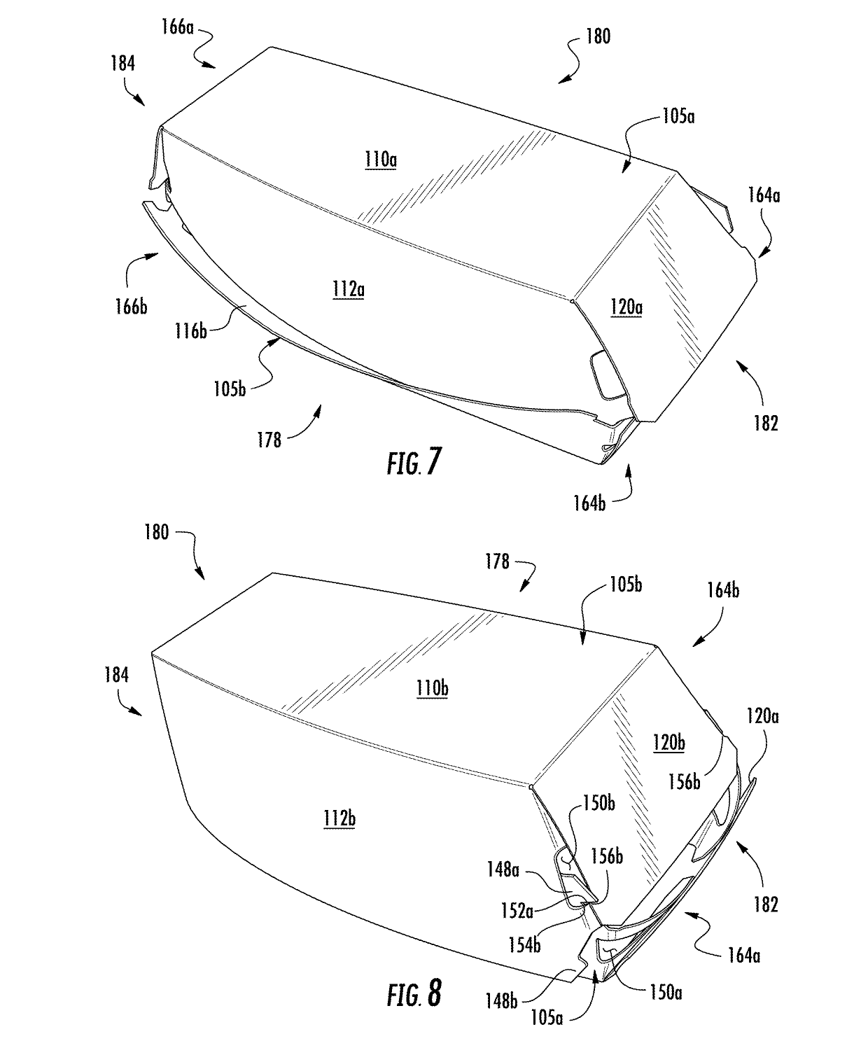

As shown in FIG. 1, the locking features 107 can include a locking projection or locking tab 148 disposed at each end of each of the side panels 112, 116 and an opening or engagement aperture 150 extending in each of the end flaps 130, 132, 138, 140 and into the respective side panels 112, 116. The locking features 107 can also include an engagement notch 156 on each side of each of the end panels 120, 124. The engagement notches 156 can be formed by each of the cut lines 146. Each of the locking tabs 148 can include a respective locking edge 152, and each of the engagement apertures 150 can include a respective engagement edge 154. Accordingly, when two constructs 105 are assembled into an interlocking relationship (e.g., FIGS. 7-9), the locking tabs 148 of one construct 105 can be at least partially received in the respective engagement apertures 150 of the other construct 105 so that the locking edges 152 of the first construct engage the respective engagement edges 154 and/or engagement notches 156 of the second construct. Any of the locking features 107 could be omitted or could be otherwise shaped, arranged, positioned, and/or configured without departing from the disclosure. For example, the engagement apertures 150 could be disposed in the respective end flaps 130, 132, 138, 140 adjacent the respective fold lines 134, 136, 142, 144 so that the engagement apertures do not interrupt the fold lines and extend into the side panels 112, 116. In another example, the engagement notches 156 could be formed in edges of the end panels 120, 124 that are spaced from the respective cut lines 146 and/or the respective end flaps 30, 132, 138, 140.

As shown in FIGS. 2-5 and described in the following in accordance with one acceptable example, the construct 105 is formed from the blank 103 by first upwardly folding the side panels 112, 116 along the respective longitudinal fold lines 114, 118 and folding the end panels 120, 124 along the respective lateral fold lines 122, 126. Each of the end flaps 130, 138 can be folded along the respective lateral fold lines 134, 142 into face-to-face contact with the interior surface of the first end panel 120 and at least partially glued and/or otherwise secured to the first end panel 120 (FIGS. 4 and 5). Additionally, each of the end flaps 132, 140 can be folded along the respective lateral fold lines 136, 144 into face-to-face contact with the interior surface of the second end panel 124 and at least partially glued and/or otherwise secured to the second end panel 124 (FIGS. 2 and 4). Accordingly, the first end panel 120 and the end flaps 130, 132 cooperate to form a first closed end 164 of the tray 105, and the second end panel 124 and the end flaps 138, 140 cooperate to form a second closed end 166 of the tray 105. In addition, as shown in FIGS. 2-5, the four corners 109 of the construct 105 are formed at the respective junctions between each of the side panels 112, 116 and the respective closed ends 164, 166 so that the fold lines 134, 136, 142, 144 extend along each of the corners 109. In the illustrated embodiment, the locking features 107 are disposed in each of the corners 109 (FIGS. 2-5). As shown in FIGS. 2 and 4, the central panel 110, the side panels 112, 116, and the closed ends 164, 166 form an interior 170 of the tray 105.

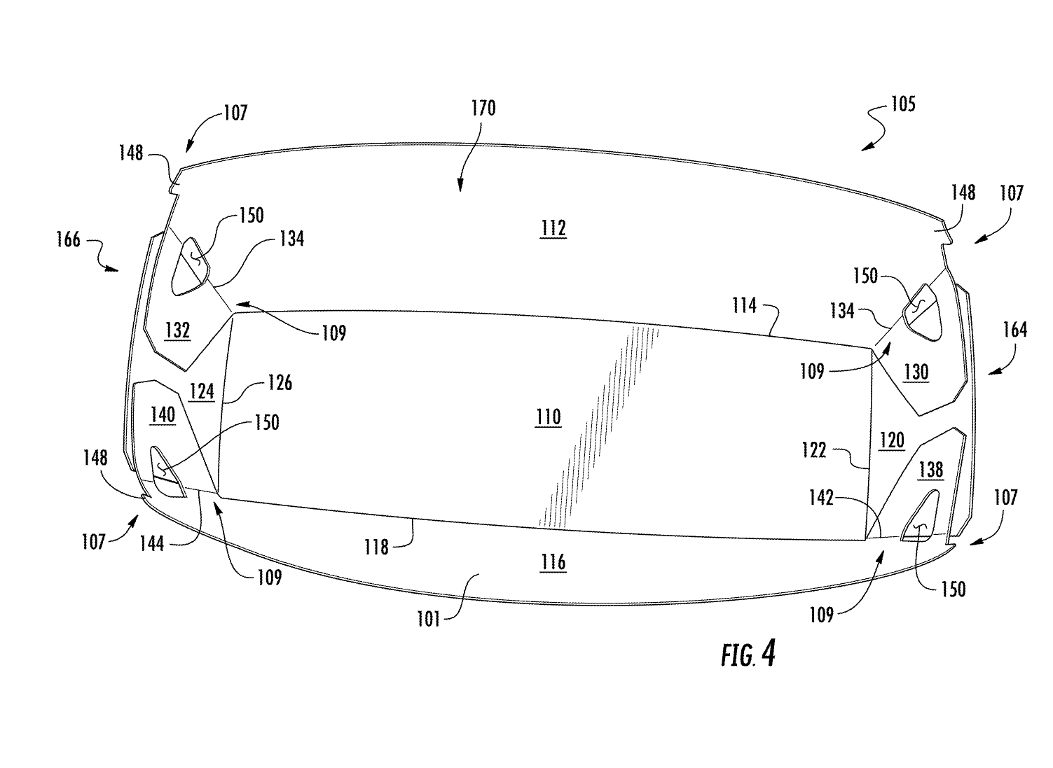

In the illustrated embodiment, as the end panels 120, 124 and the end flaps 130, 132, 138, 140 are folded relative to one another, the end panel 120 separates from the end laps 130, 138 at the cut lines 146 to form two corner edges 158 along each of the end panels 120, 124. Each of the corner edges 158 is disposed in the respective corners 109 of the construct 105 and defines a respective one of the engagement notches 156 (FIG. 3). As shown in FIGS. 2-5, the end flaps 130, 138, 132, 140 are glued to the respective end panels 120, 124 so that the engagement apertures 150 extend partially beyond the corner edges 158 of the respective end panels 120, 124 to provide clearance for receiving the locking tabs 148 of another construct 105. In one embodiment, as shown in FIG. 3, the engagement notches 156 can be generally aligned with the respective engagement edges 154 at each corner 109 so that the locking edges 152 of the locking tabs 148 of another construct can engage the engagement edge 154 and/or the engagement notch 156 at the respective corners 109. Alternatively, the engagement notch 156 could be proximate to the engagement apertures 150 at each corner, or the engagement notches 156 could be omitted.

Alternative assembling, loading, and closing steps may be used without departing from the scope of the disclosure. For example, the end flaps 130, 138, 132, 140 can be folded into face-to-face contact with the exterior surfaces of the respective end panels 120, 124. In addition, the construct 105 can be formed by press-forming a blank in a forming tool, or the construct 150 could be formed by other methods.

According to one embodiment, FIG. 5 shows the closed end 164 and two corners 109 of the construct 105 from the interior of the construct. The opposing corners 109 and the closed end 166 are similarly or identically configured. As shown in FIG. 5, the locking tabs 148 are disposed proximate to the respective engagement apertures 150 at each corner 109. In the illustrated embodiment, the locking tabs 148 extend outwardly from a respective end edge 160 of the respective side panels 112, 116 and along or adjacent a respective top edge 162 of the respective side panels 112, 116. Accordingly, the locking edges 152 can extend from the respective end edges 160 at the respective corners 109. Alternatively, any of the corners 109 and/or the locking features 107 could be otherwise shaped, arranged, positioned, and/or configured without departing from the disclosure.

As shown in FIGS. 6-9, two constructs 105, which can be selected from a stack of constructs (not shown) in one embodiment, can form the package 178 and can be assembled into an interlocking relationship to form the assembly 180. While the constructs shown in FIGS. 6-9 are generally identical, each of the constructs 105 being formed from a respective blank 103, the top construct or lid and the features thereof are indicated by an appended “a” on the reference number (e.g., the lid 105a), and the bottom construct or tray and the features thereof are indicated by an appended “b” on the reference number (e.g., the tray 105b). As shown in FIG. 6, the lid 105a can be positioned over the tray 105b with the interiors 170a, 170b of the trays directed toward one another. As shown in FIG. 7, the lid 105a can be moved toward the tray 105b so that the lid side panels 112a, 116a are generally inside the tray side panels 112b, 116b and the lid corners 109a are generally aligned with the respective tray corners 109b.

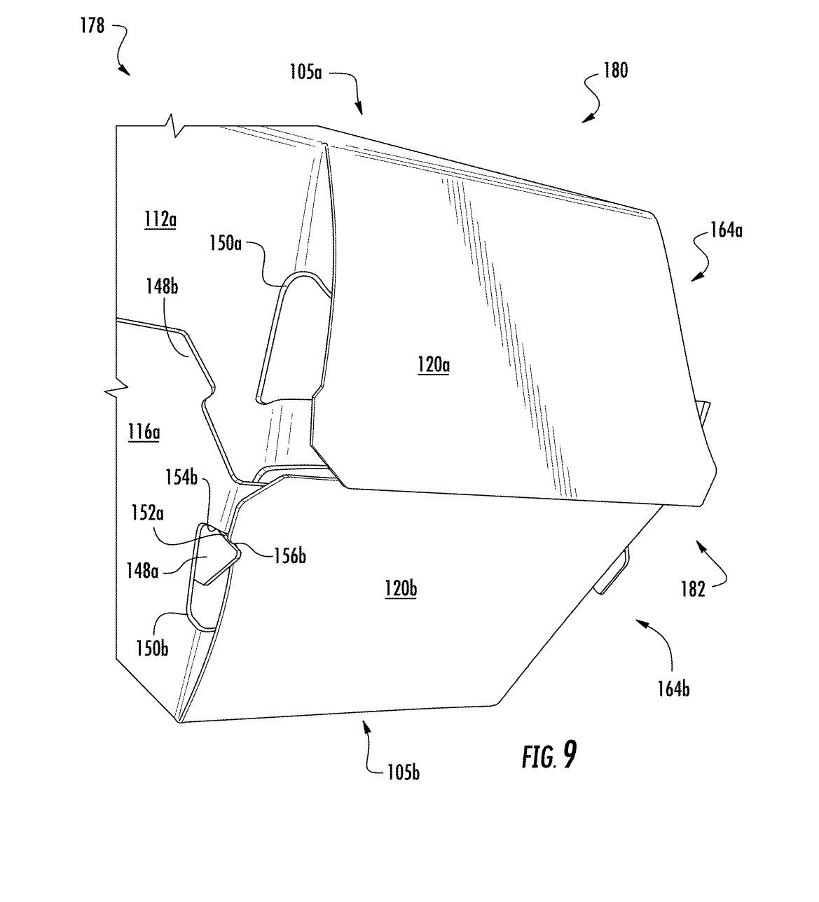

In the illustrated embodiment, as shown in at least FIGS. 8 and 9, the lid locking tabs 148a are inserted into the respective tray engagement apertures 150b so that each of the lid locking edges 152a engages the respective tray engagement edges 154b and/or the respective tray engagement notches 156b to at least partially interlock the lid 105a and the tray 105b and to help retain the lid 105a in the assembly with the tray 105b. In one embodiment, the lid 105a can be pivoted so that the lid locking features 107a at one of the lid ends 164a, 166a are interlocked with the tray locking features 107b at one of the tray ends 164b, 166b and then the opposing lid end is lowered to be engaged with the opposing tray end. For example, as shown in FIG. 6, the lid locking features 107a at the lid corners 109a adjacent the lid end 166a can be interlocked with the tray locking features 107b at the tray corners 109b adjacent the tray end 166b. The lid 105a can be pivoted so that the lid end 164a moves toward the tray end 164b and the lid locking features 107a at the lid corners 109a adjacent the lid end 164a can be interlocked with the tray locking features 107b at the tray corners 109b adjacent the tray end 164b. In the illustrated embodiment, as shown in FIGS. 7 and 8, the lid end 164a and the tray end 164b form a first end 182 of the package 178 and the assembly 180 and the lid end 166a and the tray end 166b form a second end 184 of the package 178 and the assembly 180. In an alternative embodiment, the lid ends 164a, 166a could be aligned with the respective tray ends 166b, 164b.

The assembly 180 of the tray 105b and the lid 105a is shown in FIGS. 7-9. The lid 105a can be removed from the tray 105b by disengaging the lid locking tabs 148a from the tray engagement apertures 150b and pulling the lid 105a away from the tray 105b. In one embodiment, the lid locking tabs 148a can be disengaged from the tray engagement apertures 150b by pinching the lid side panels 112a, 116a so that the lid locking tabs 148a at the ends of the lid side panels 112a, 116a are moved towards the tray interior 170b away from the tray side panels 112b, 116b. The constructs 105 can be alternatively erected and/or the assembly 180 can be alternatively formed and/or disassembled without departing from the disclosure.

In an alternative embodiment, the lid side panels 112a, 116a can be generally outside the tray side panels 112b, 116b, and the tray locking tabs 148b can be received in the respective lid engagement apertures 150a without departing from the disclosure. In one embodiment, to disengage the lid 105a from the tray 105b in this alternative configuration, the tray side panels 112b, 116b can be pinched to move the tray locking tabs 148b towards the lid interior 170 away from the lid side panels 112a, 116a and to disengage the tray locking tabs 148b from the respective lid engagement apertures 150a. The tray 105b and/or the lid 105a could be alternatively configured, shaped, positioned, and/or arranged without departing from the disclosure.

In the illustrated embodiment, the terms “lid” and “tray” are generally interchangeable and are used in the description and claims only to differentiate between the constructs and their features for clarity since the constructs 105a, 105b are identical, substantially identical, or generally identical. Stated another way, the assembly 180 could be inverted so that the construct 105a forms the “tray” on the bottom of the assembly and the construct 105b forms the “lid” on top of the assembly. In addition, the lid locking tabs 148a engaging the tray engagement apertures 150b as shown and described in the illustrated embodiment is essentially equivalent to the “tray” locking tabs 148a engaging the “lid” engagement apertures 150b.

In the illustrated embodiment, the construct 105 is versatile, convenient, and efficient at least because the construct 105 has both a locking tab 148 and an engagement aperture 150 at each of its corners 109 (e.g., at each end of the side panels 112, 116). Each corner 109 of the construct 105 can act as female locking feature (e.g., receiving locking tabs from a separate construct in the respective engagement apertures 150 in the construct 105) or a male locking feature (e.g., the locking tabs 148 being received in respective engagement apertures in a separate construct). Accordingly, when serving food for takeout, for example, the food product can be placed in a first construct 105 (e.g., that was taken from a stack of nested constructs, not shown), and a second construct 105 (e.g., which can be taken from the same stack as the first construct) can be interlocked with the first construct to form the assembly 180 as described above. In one embodiment, only one stack of constructs 105 is needed for the supply of lids and trays. In alternative packages where the lid is different than the tray, the lids and trays would be arranged in separate stacks that can take up valuable space. In situations where a lid is not needed, such as for when a patron is dining in at a quick-service restaurant in one example, a single construct 105 can be used as a tray to serve a food product without a lid. In contrast, in a different style of container with a lid that is different than the tray or wherein the lid is attached to the tray (e.g., a clamshell container), the unneeded lid is wasted material and takes up additional space. Accordingly, in situations where a lid is needed for the tray in some occasions and a lid is not needed for the tray in other occasions, the construct 105, which can serve as either a tray or as a lid in cooperation with another construct 105, is more convenient and efficient.

The blank 103 and/or the construct 105 and/or the assembly 180 could be otherwise shaped, arranged, positioned, and/or configured without departing from the disclosure. The blank and construct described above are included by way of example. For example, the shapes of the overall construct and/or the locking features could be any suitable shape. The shapes described above and included in the figures are included by way of example, and the construct 105 could have any suitable number of corners 109 and/or locking features 107 without departing from the disclosure.

In general, the blank may be constructed from paperboard having a caliper so that it is heavier and more rigid than ordinary paper. The blank can also be constructed of other materials, such as cardboard, or any other material having properties suitable for enabling the carton to function at least generally as described above. The blank can be coated with, for example, a clay coating. The clay coating may then be printed over with product, advertising, and other information or images. The blank may then be coated with a varnish to protect information printed on the blanks. The blank may also be coated with, for example, a moisture barrier layer, on either or both sides of the blanks. The blank can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A construct for holding at least one article, the construct comprising:
a plurality of panels extending at least partially around an interior of the construct, the plurality of panels at least partially forming a corner of the construct; and
locking features for at least partially interlocking the construct with a separate construct, the locking features comprising at least a locking tab and an engagement aperture, the locking tab being proximate the engagement aperture at the corner of the construct.

2. The construct of claim 1, wherein the plurality of panels comprises a side panel and an end panel, an end flap is foldably connected to the side panel, the end panel and the end flap at least partially overlap one another, and the corner of the construct is at least partially defined by the side panel and the end flap.

3. The construct of claim 2, wherein the locking tab extends from an edge of the side panel at the corner, and the engagement aperture extends in the end flap adjacent the corner.

4. The construct of claim 3, wherein the end flap is foldably connected to the side panel along a fold line, the fold line extends along the corner, and the engagement aperture interrupts the fold line.

5. The construct of claim 2, wherein the corner is a first corner, the side panel is a first side panel, and the end flap is a first end flap, the plurality of panels further comprises a second side panel, a second end flap is foldably connected to the second side panel, the end panel and the second end flap at least partially overlap one another, and the second side panel and the second end flap at least partially define a second corner of the construct.

6. The construct of claim 5, wherein the locking tab is a first locking tab and the engagement aperture is a first engagement aperture, and the locking features further comprise a second locking tab and a second engagement aperture, the second locking tab being proximate the second engagement aperture at the second corner of the construct.

7. The construct of claim 6, wherein each of the first locking tab and the second locking tab extends from a respective edge of the respective first side panel and second side panel at the respective first corner and second corner, and each of the first engagement aperture and the second engagement aperture extends in the respective first end flap and second end flap adjacent the respective first corner and second corner.

8. The construct of claim 6, wherein:
the end panel is a first end panel, and the plurality of panels comprises a second end panel disposed opposite to the first end panel;
a third end flap is foldably connected to the first side panel, a fourth end flap is foldably connected to the second side panel, the second end panel and each of the third end flap and the fourth end flap respectively at least partially overlap one another;
the first side panel and the third end flap at least partially define a third corner of the construct, and the second side panel and the fourth end flap at least partially define a fourth corner of the construct; and
the locking features further comprises a third locking tab, a third engagement aperture, a fourth locking tab, and a fourth engagement aperture, the third locking tab being proximate the third engagement aperture at the third corner of the construct, and the fourth locking tab being proximate the fourth engagement aperture at the fourth corner of the construct.

9. The construct of claim 1, wherein the plurality of panels comprises a side panel, the side panel comprises a top edge and an end edge, and the locking tab extends outwardly from the end edge adjacent the top edge.

10. The construct of claim 9, wherein the end edge extends in the corner of the construct, and the top edge extends away from the corner.

11. The construct of claim 9, wherein the locking tab comprises a locking edge extending from the end edge of the side panel.

12. The construct of claim 1, wherein the plurality of panels comprises a side panel and an end panel, the locking tab extends from the side panel at the corner of the construct, the end panel comprises a corner edge extending adjacent the corner of the construct, and the locking features further comprise an engagement notch in the corner edge of the end panel.

13. The construct of claim 12, wherein an end flap is foldably connected to the side panel, the end panel and the end flap at least partially overlap one another, the engagement aperture extends in the end flap adjacent the corner, the engagement aperture comprises an engagement edge, and the engagement notch is generally aligned with the engagement edge of the engagement aperture.

14. The construct of claim 1, wherein the plurality of panels comprises a side panel, an end flap is foldably connected to the side panel along a fold line, the corner of the construct is at least partially defined by the side panel and the end flap, the fold line extends along the corner, the locking tab extends from the side panel at the corner, and the engagement aperture extends in the end flap adjacent the corner.

15. The construct of claim 14, wherein the side panel comprises an end edge at the corner of the construct, the locking tab extends outwardly from the end edge, and the locking tab is spaced apart from the end flap by the end edge.

16. A package for holding at least one article, the package comprising:
a first construct forming a tray of the package, the tray comprising a plurality of tray panels extending at least partially around an interior of the package, a tray locking tab, and a tray engagement aperture, the plurality of tray panels at least partially forming a tray corner, the tray locking tab extending from a tray panel of the plurality of tray panels at the tray corner, and the tray engagement aperture extending at the tray corner;
a second construct forming a lid of the package, the lid comprising a plurality of lid panels extending at least partially around an interior of the package, a lid locking tab, and a lid engagement aperture, the plurality of lid panels at least partially forming a lid corner, the lid locking tab extending from a lid panel of the plurality of lid panels at the lid corner, and the lid engagement aperture extending at the lid corner;
wherein the lid locking tab and the lid engagement aperture are for selectively engaging the respective tray engagement aperture and tray locking tab to at least partially interlock the tray and the lid.

17. The package of claim 16, wherein the first construct and the second construct are substantially identical to one another.

18. The package of claim 17, wherein the first construct and the second construct are selected from a stack of substantially identical constructs.

19. The package of claim 16, wherein:
the plurality of tray panels comprises a tray side panel, a tray end flap is foldably connected to the tray side panel at the corner, and the tray locking tab extends outwardly from the tray side panel at the corner;
the plurality of lid panels comprises a lid side panel, a lid end flap is foldably connected to the lid side panel at the corner, and the lid locking tab extends outwardly from the lid side panel at the corner.

20. The package of claim 19, wherein the tray engagement aperture and the lid engagement aperture extend in the respective tray end flap and lid end flap at the respective tray corner and lid corner.

21. The package of claim 20, wherein the plurality of tray panels further comprises a tray end panel, the plurality of lid panels further comprises a lid end panel, the tray end panel and the tray end flap at least partially overlap one another at an end of the package, the lid end panel and the lid end flap at least partially overlap one another at the end of the package, and each of the tray end panel and the lid end panel comprises a respective engagement notch at least partially aligned with the respective tray engagement aperture and lid engagement aperture in the respective tray end flap and lid end flap.

22. The package of claim 19, wherein the tray end flap and the lid end flap are foldably connected to the respective tray side panel and lid side panel along a respective tray fold line and lid fold line, and the tray fold line and the lid fold line extend along the respective tray corner and lid corner.

23. The package of claim 22, wherein the tray locking tab and the lid locking tab extend from respective end edges of the respective tray side panel and lid side panel, the end edges extending generally upwardly from the respective tray fold line and the lid fold line.

24. The package of claim 23, wherein the tray side panel and the lid side panel comprise respective top edges, the tray locking tab and the lid locking tab extending adjacent the respective top edge of the respective tray side panel and lid side panel.

25. The package of claim 16, wherein the plurality of tray panels comprises a tray side panel and a tray end panel, and the plurality of lid panels comprises a lid side panel and a lid end panel, the tray locking tab and the lid locking tab extending from the respective tray side panel and lid side panel at the respective tray corner and lid corner.

26. The package of claim 25, wherein the tray end panel and the lid end panel comprise respective tray engagement notch and lid engagement notch at the respective tray corner and lid corner, the tray locking tab and the lid locking tab being for selectively engaging the respective lid engagement notch and tray engagement notch to at least partially interlock the tray and the lid.

27. The package of claim 16, wherein:
the tray corner is a first tray corner, the tray locking tab is a first tray locking tab, the tray engagement aperture is a first tray engagement aperture, the lid corner is a first lid corner, the lid locking tab is a first lid locking tab, and the lid engagement aperture is a first lid engagement aperture;
the plurality of tray panels at least partially form a second tray corner, and the tray further comprises a second tray locking tab and a second tray engagement aperture, the second tray locking tab and the second tray engagement aperture extending at the second tray corner;
the plurality of lid panels at least partially form a second lid corner, and the lid further comprises a second lid locking tab and a second lid engagement aperture, the second lid locking tab and the second lid engagement aperture extending at the second lid corner; and
the second lid locking tab and the second lid engagement aperture are for selectively engaging the respective second tray engagement aperture and second tray locking tab to at least partially interlock the tray and the lid.

28. The package of claim 27, wherein:
the plurality of tray panels comprises a first tray side panel and a second tray side panel, the first tray locking tab extends outwardly from the first tray side panel at the first tray corner, and the second tray locking tab extends outwardly from the second tray side panel at the second tray corner; and
the plurality of lid panels comprises a first lid side panel and a second lid side panel, the first lid locking tab extends outwardly from the first lid side panel at the first lid corner, and the second lid locking tab extends outwardly from the second lid side panel at the second lid corner.

29. The package of claim 28, wherein
a first tray end flap and a second tray end flap are foldably connected to the respective first tray side panel and second tray side panel at the respective first tray corner and second tray corner, and the first tray engagement aperture and the second tray engagement aperture extend in the respective first tray end flap and second tray end flap at the respective first tray corner and second tray corner; and
a first lid end flap and a second lid end flap are foldably connected to the respective first lid side panel and second lid side panel at the respective first lid corner and second lid corner, and the first lid engagement aperture and the second lid engagement aperture extend in the respective first lid end flap and second lid end flap at the respective first lid corner and second lid corner.

30. The package of claim 29, wherein the plurality of tray panels further comprises a tray end panel, the tray end panel is at least partially overlapped with the first tray end flap and the second tray end flap, the plurality of lid panels further comprises a lid end panel, and the lid end panel is at least partially overlapped with the first lid end flap and the second lid end flap.

31. The package of claim 28, wherein the plurality of tray panels further comprises a tray end panel, the tray end panel extends from the first tray corner to the second tray corner, the plurality of lid panels further comprises a lid end panel, and the lid end panel extends from the first lid corner to the second lid corner.

32. The package of claim 27, wherein:
the plurality of tray panels comprises a tray side panel extending from the first tray corner to the second tray corner, the first tray locking tab and the second tray locking tab extending from respective ends of the tray side panel at the respective first tray corner and second tray corner; and
the plurality of lid panels comprises a lid side panel extending from the first lid corner to the second lid corner, the first lid locking tab and the second lid locking tab extending from respective ends of the lid side panel at the respective first lid corner and second lid corner.

33. The package of claim 32, wherein:
a first tray end flap and a second tray end flap are foldably connected to the respective ends of the tray side panel at the respective first tray corner and second tray corner, and the first tray engagement aperture and the second tray engagement aperture extend in the respective first tray end flap and second tray end flap at the respective first tray corner and second tray corner; and
a first lid end flap and a second lid end flap are foldably connected to the respective ends of the lid side panel at the respective first lid corner and second lid corner, and the first lid engagement aperture and the second lid engagement aperture extend in the respective first lid end flap and second lid end flap at the respective first lid corner and second lid corner.

34. The package of claim 33, wherein:
the plurality of tray panels further comprises a first tray end panel and a second tray end panel, the first tray end flap and the first tray end panel are at least partially overlapped with one another at a first end of the package, and the second tray end flap and the second tray end panel are at least partially overlapped with one another at a second end of the package; and
the plurality of lid panels further comprises a first lid end panel and a second lid end panel, the first lid end flap and the first lid end panel are at least partially overlapped with one another at the first end of the package, and the second lid end flap and the second lid end panel are at least partially overlapped with one another at the second end of the package.

35. The package of claim 27, wherein:
each of the first tray corner, the second tray corner, the first lid corner, and the second lid corner is disposed at a first end of the package;
the plurality of tray panels at least partially form third tray corner and a fourth tray corner, each disposed at a second end of the package, the tray further comprises a third tray locking tab, a third tray engagement aperture, a fourth tray locking tab, and a fourth tray engagement aperture, the third tray locking tab and a third tray engagement aperture extending at the third tray corner, and the fourth tray locking tab and the fourth tray engagement aperture extending at the fourth tray corner;
the plurality of lid panels at least partially form third lid corner and a fourth lid corner, each disposed at the second end of the package, the lid further comprises a third lid locking tab, a third lid engagement aperture, a fourth lid locking tab, and a fourth lid engagement aperture, the third lid locking tab and a third lid engagement aperture extending at the third lid corner, and the fourth lid locking tab and the fourth lid engagement aperture extending at the fourth lid corner; and
the third lid locking tab, the third lid engagement aperture, the fourth lid locking tab, and the fourth lid engagement aperture are for selectively engaging the respective third tray engagement aperture, third tray locking tab, fourth tray engagement aperture, and fourth tray locking tab to at least partially interlock the tray and the lid.

36. The package of claim 16, wherein one of the lid locking tab and the lid engagement aperture is at least partially engaged with the respective tray engagement aperture and tray locking tab to at least partially interlock the tray and the lid.

37. A blank for forming a construct for holding at least one article, the blank comprising:
a plurality of panels for being disposed at least partially around an interior of the construct formed from the blank to at least partially form a corner of the construct formed from the blank; and
locking features for at least partially interlocking the construct formed from the blank with a separate construct, the locking features comprising at least a locking tab and an engagement aperture, the locking tab being proximate the engagement aperture at the corner when the construct is formed from the blank.

38. The blank of claim 37, wherein the plurality of panels comprises a side panel and an end panel, an end flap is foldably connected to the side panel, the end panel and the end flap are for at least partially overlapping one another when the construct is formed from the blank, and the corner of the construct is for being at least partially defined by the side panel and the end flap when the construct is formed from the blank.

39. The blank of claim 38, wherein the locking tab extends from an edge of the side panel, the engagement aperture extends in the end flap, and the locking tab is for extending from the edge of the side panel at the corner and the engagement aperture is for extending adjacent the corner when the construct is formed from the blank.

40. The blank of claim 39, wherein the end flap is foldably connected to the side panel along a fold line, the engagement aperture interrupts the fold line, and the fold line is for extending along the corner when the construct is formed from the blank.

41. The blank of claim 38, wherein the corner is a first corner, the side panel is a first side panel, and the end flap is a first end flap, the plurality of panels further comprises a second side panel, a second end flap is foldably connected to the second side panel, the end panel and the second end flap at least partially overlap one another, and the second side panel and the second end flap are for at least partially defining a second corner of the construct formed from the blank.

42. The blank of claim 41, wherein the locking tab is a first locking tab and the engagement aperture is a first engagement aperture, and the locking features further comprise a second locking tab and a second engagement aperture, the second locking tab being proximate the second engagement aperture at the second corner of the construct when the construct is formed from the blank.

43. The blank of claim 42, wherein:
the end panel is a first end panel, and the plurality of panels comprises a second end panel for being disposed opposite to the first end panel when the construct is formed from the blank;
a third end flap is foldably connected to the first side panel, a fourth end flap is foldably connected to the second side panel, the second end panel and each of the third end flap and the fourth end flap are for respectively at least partially overlapping one another when the construct is formed from the blank;
the first side panel and the third end flap at least partially define a third corner of the construct formed from the blank, and the second side panel and the fourth end flap at least partially define a fourth corner of the construct formed from the blank; and
the locking features further comprises a third locking tab, a third engagement aperture, a fourth locking tab, and a fourth engagement aperture, the third locking tab being for extending proximate the third engagement aperture at the third corner when the construct is formed from the blank, and the fourth locking tab being for extending proximate the fourth engagement aperture at the fourth corner when the construct is formed from the blank.

44. The blank of claim 37, wherein the plurality of panels comprises a side panel, the side panel comprises a top edge and an end edge, and the locking tab extends outwardly from the end edge adjacent the top edge.

45. The blank of claim 44, wherein the end edge is for extending in the corner of the construct formed from the blank, and the top edge is for extending away from the corner when the construct is formed from the blank.

46. The blank of claim 44, wherein the locking tab comprises a locking edge extending from the end edge of the side panel.

47. The blank of claim 37, wherein the plurality of panels comprises a side panel and an end panel, the locking tab extends from the side panel, the end panel comprises a corner edge, the corner edge is for extending adjacent the corner when the construct is formed from the blank, and the locking features further comprise an engagement notch in the corner edge of the end panel.

48. The blank of claim 47, wherein an end flap is foldably connected to the side panel, the engagement aperture extends in the end flap, the engagement aperture comprises an engagement edge, the end panel and the end flap are for at least partially overlapping one another when the construct is formed from the blank, and the engagement notch is for being generally aligned with the engagement edge of the engagement aperture when the construct is formed from the blank.

49. The blank of claim 37, wherein the plurality of panels comprises a side panel, an end flap is foldably connected to the side panel along a fold line, the locking tab extends from an end of the side panel, the engagement aperture extends in the end flap, and the corner of the construct is for being at least partially defined by the side panel and the end flap when the construct is formed from the blank

50. The blank of claim 49, wherein the side panel comprises an end edge, the locking tab extends outwardly from the end edge, the locking tab is spaced apart from the end flap by the end edge, and the end edge is for extending at the corner when the construct is formed from the blank.

51. A method of forming a construct, the method comprising:
obtaining a blank comprising a plurality of panels and locking features, the locking features comprising at least a locking tab and an engagement aperture;
positioning the panels of the plurality of panels to extend at least partially around an interior of the construct, the positioning the panels comprises forming a corner of the construct, wherein the locking tab is proximate the engagement aperture at the corner of the construct.

52. The method of claim 51, wherein the plurality of panels comprises a side panel and an end panel, an end flap is foldably connected to the side panel, the positioning the panels comprises folding the end flap with respect to the side panel to at least partially define the corner of the construct and positioning the end panel and the end flap to at least partially overlap one another.

53. The method of claim 52, wherein the corner is a first corner, the side panel is a first side panel, and the end flap is a first end flap, the plurality of panels further comprises a second side panel, a second end flap is foldably connected to the second side panel, the positioning the panels further comprises folding the second end flap with respect to the second side panel to at least partially define the second corner of the construct and positioning the end panel and the second end flap to at least partially overlap one another.

54. The method of claim 53, wherein the locking tab is a first locking tab and the engagement aperture is a first engagement aperture, and the locking features further comprise a second locking tab and a second engagement aperture, the second locking tab being proximate the second engagement aperture at the second corner of the construct.

55. The method of claim 51, wherein the plurality of panels comprises a side panel, an end flap is foldably connected to the side panel along a fold line, and the forming the corner of the construct comprises folding the end flap with respect to the side panel along the fold line to at least partially define the corner so that the fold line extends along the corner, the locking tab extending from the side panel at the corner and the engagement aperture extending in the end flap adjacent the corner.

56. A method of forming an assembly, the method comprising:
obtaining a first construct and a second construct, wherein
the first construct forms a tray of the package, the tray comprising a plurality of tray panels extending at least partially around an interior of the package, a tray locking tab, and a tray engagement aperture, the plurality of tray panels at least partially forming a tray corner, the tray locking tab extending from a tray panel of the plurality of tray panels at the tray corner, and the tray engagement aperture extending at the tray corner, and
the second construct forms a lid of the package, the lid comprising a plurality of lid panels extending at least partially around an interior of the package, a lid locking tab, and a lid engagement aperture, the plurality of lid panels at least partially forming a lid corner, the lid locking tab extending from a lid panel of the plurality of lid panels at the lid corner, and the lid engagement aperture extending at the lid corner; and
at least partially interlocking the first construct with the second construct by disposing at least one of the lid locking tab and the tray locking tab to be at least partially received in the respective tray engagement aperture and lid engagement aperture.

57. The method of claim 56, wherein the at least partially interlocking the first construct with the second construct comprises engaging a locking edge of the lid locking tab with an engagement edge of the tray engagement aperture.

58. The method of claim 56, wherein the first construct and the second construct are generally identical to one another, and the obtaining the first construct and the second construct comprises selecting each of the first construct and the second construct from a stack of generally identical constructs.

59. The method of claim 56, wherein:
the plurality of tray panels comprises a tray side panel, a tray end flap is foldably connected to the tray side panel at the corner, the tray locking tab extends outwardly from the tray side panel at the corner, and the tray engagement aperture extends in the tray end flap an at the tray corner; and
the plurality of lid panels comprises a lid side panel, a lid end flap is foldably connected to the lid side panel at the corner, the lid locking tab extends outwardly from the lid side panel at the corner, and the lid engagement aperture extends in the lid end flap an at the lid corner.

60. The method of claim 59, wherein:
the plurality of tray panels further comprises a tray end panel, the plurality of lid panels further comprises a lid end panel, and each of the tray end panel and the lid end panel comprises a respective engagement notch;
the tray end panel and the tray end flap at least partially overlap one another at an end of the package, the lid end panel and the lid end flap at least partially overlap one another at the end of the package, and the engagement notches of the tray end panel and the lid end panel are disposed adjacent the respective tray engagement aperture and lid engagement aperture in the respective tray end flap and lid end flap; and
the at least partially interlocking the first construct with the second construct further comprises engaging the lid locking tab with at least one of the tray engagement aperture and the engagement notch of the tray end panel.

61. The method of claim 60, wherein the tray engagement aperture comprises an engagement edge, the engagement notch of the tray end panel is at least partially aligned with the engagement edge of the tray engagement aperture, and the engaging the lid locking tab with at least one of the tray engagement aperture and the engagement notch of the tray end panel further comprises engaging the lid locking tab with each of the engagement edge of the tray engagement aperture and the engagement notch of the tray end panel.

62. The method of claim 56, wherein:
the tray corner is a first tray corner, the tray locking tab is a first tray locking tab, the tray engagement aperture is a first tray engagement aperture, the lid corner is a first lid corner, the lid locking tab is a first lid locking tab, and the lid engagement aperture is a first lid engagement aperture;
the plurality of tray panels at least partially form a second tray corner, and the tray further comprises a second tray locking tab and a second tray engagement aperture, the second tray locking tab and the second tray engagement aperture extending at the second tray corner;
the plurality of lid panels at least partially form a second lid corner, and the lid further comprises a second lid locking tab and a second lid engagement aperture, the second lid locking tab and the second lid engagement aperture extending at the second lid corner; and
the at least partially interlocking the first construct with the second construct further comprises disposing at least one of the second lid locking tab and the second tray locking tab to be at least partially received in the respective second tray engagement aperture and second lid engagement aperture.
